(19) United States
(12) Patent Application Publication
(10) Pub. No.: US 2025/0260550 A1
(43) Pub. Date: Aug. 14, 2025

(54) TIME DIVISION DUPLEXING (TDD) COVERAGE ENHANCEMENT IN FREQUENCY DIVISION DUPLEXING (FDD)-TDD CARRIER AGGREGATION (CA)

(71) Applicant: DISH Wireless L.L.C., Englewood, CO (US)

(72) Inventors: Sang Boh YUN, Ashburn, VA (US); JooHyun LEE, Gyeonggi-do (KR); Gurpreet SOHI, Parker, CO (US); Siddhartha CHENUMOLU, Ashburn, VA (US)

(73) Assignee: DISH Wireless L.L.C., Englewood, CO (US)

(21) Appl. No.: 18/439,624

(22) Filed: Feb. 12, 2024

(51) Int. Cl. H04L 5/14; H04W 72/232

(52) U.S. Cl. CPC H04L 5/14; H04W 72/232

(57) ABSTRACT

Time Division Duplexing (TDD) coverage enhancement in Frequency Division Duplexing (FDD)-TDD Carrier Aggregation (CA) is disclosed. The Physical Downlink Control Channel (PDCCH) configurations of the serving cell and its adjacent cells are collected and PDCCH coverage improvement techniques suitable for each cell and user situation are employed. Various data measurements are acquired to detect users with insufficient PDCCH coverage. A PDCCH allocation map is constructed between the serving cell and its adjacent cells and configuration information is exchanged with the adjacent cells. PDCCH configurations are then optimized for target users at or near the TDD cell edge in near-real time. For instance, the PDCCH Aggregation Level (AL) may be changed, PDCCH power may be boosted, PDCCH beamforming and precoding may be performed, inter-cell PDCCH coordination may be performed, cross-carrier scheduling may be performed, multi-Transmission Reception Point (TRP) PDCCH transmission may be performed, etc.

### FIELD

The present invention generally relates to communications, and more specifically, to Time Division Duplexing (TDD) coverage enhancement in Frequency Division Duplexing (FDD)-TDD Carrier Aggregation (CA).

### BACKGROUND

Low-band (less than one gigahertz (GHz) and mid-band (1-6 GHz) FDD provides a relatively wide coverage area. However, due to spectrum acquisition costs, FDD bandwidth may be insufficient, making it difficult to accommodate increased user data rates. By adding higher band TDD to an FDD site and applying CA to the FDD and TDD bands, downlink (DL) throughput can be more than doubled.

However, the co-sited TDD band(s) have a smaller coverage area than the FDD band(s). As such, the DL throughput gain obtained from DL CA is limited to the smaller TDD coverage area. Accordingly, an improved and/or alternative approach may be beneficial.

### SUMMARY

Certain embodiments of the present invention may provide solutions to the problems and needs in the art that have not yet been fully identified, appreciated, or solved by current communications technologies, and/or provide a useful alternative thereto. For example, some embodiments of the present invention pertain to TDD coverage enhancement in FDD-TDD CA.

In an embodiment, one or more non-transitory computer-readable media store one or more computer programs for performing TDD coverage enhancement in FDD-TDD CA. The one or more computer programs are configured to cause at least one processor to collect data measurements from one or more Radio Access Network (RAN) nodes. The one or more computer programs are also configured to cause the at least one processor to perform a CA coverage and balance check using the collected data measurements and detect one or more User Equipment (UE) devices using FDD-TDD CA in a target TDD cell that have insufficient coverage as defined by one or more metrics based on the CA coverage and balance check. The one or more computer programs are further configured to cause the at least one processor to determine modifications to Physical Downlink Control Channel (PDCCH) settings for the one or more UE devices based on a PDCCH-related policy and transmit the PDCCH settings modifications to at least one of the one or more RAN nodes to implement the modifications to the PDCCH settings for the one or more UE devices.

In another embodiment, one or more computing systems include memory storing computer program instructions for performing TDD coverage enhancement in FDD-TDD CA and at least one processor configured to execute the computer program instructions. The computer instructions are configured to cause the at least one processor to collect data measurements from one or more RAN nodes and detect one or more UE devices using FDD-TDD CA in a target TDD cell that have insufficient coverage as defined by one or more metrics. The computer instructions are configured to cause the at least one processor to determine modifications to PDCCH settings for the one or more UE devices based on a PDCCH-related policy and one or more Artificial Intelligence (AI)/Machine Learning (ML) model inferences. The computer instructions are further configured to cause the at least one processor to transmit the PDCCH settings modifications to at least one of the one or more RAN nodes to implement the modifications to the PDCCH settings for the one or more UE devices to improve coverage for the one or more UE devices in the target TDD cell.

In yet another embodiment, a computer-implemented method for performing TDD coverage enhancement in FDD-TDD CA includes detecting one or more UE devices using FDD-TDD CA in a target TDD cell that have insufficient coverage as defined by one or more metrics, by one or more computing systems. The computer-implemented method also includes determining modifications to PDCCH settings for the one or more UE devices based on a PDCCH-related policy and one or more AI/ML model inferences, by the one or more computing systems. The computer-implemented method further includes providing the PDCCH settings modifications to at least one of the one or more RAN nodes to implement the modifications to the PDCCH settings for the one or more UE devices to improve coverage for the one or more UE devices in the target TDD cell, by the one or more computing systems. The one or more AI/ML model inferences include a PDCCH Aggregation Level (AL) change, a PDCCH power boost, PDCCH beamforming and precoding changes, inter-cell PDCCH coordination, cross-carrier scheduling, multi-Transmission Reception Point (TRP) PDCCH transmission, or any combination thereof.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating an Open Radio Access Network (O-RAN) that is configured to provide TDD coverage enhancement in TDD-FDD CA, according to an embodiment of the present invention.

FIG. 2 is a graph illustrating a link budget comparison, according to an embodiment of the present invention.

FIG. 3 is a coverage map illustrating coverage areas provided by an FDD band, a TDD band, and FDD+TDD CA with TDD coverage enhancement, according to an embodiment of the present invention.

FIG. 4 is a flowchart illustrating a process for providing TDD coverage enhancement in TDD-FDD CA, according to an embodiment of the present invention.

FIGS. 5A-C illustrate symbol and Resource Block (RB) assignments for a slot without power boosting, with a 3 decibel (dB) power boost, and with a 6 dB power boost, respectively, according to an embodiment of the present invention.

FIGS. 6A and 6B illustrate inter-cell PDCCH coordination, according to an embodiment of the present invention.

FIG. 7 is a flow diagram illustrating a functional framework for RAN intelligence, according to an embodiment of the present invention.

FIG. 8 is an architectural diagram illustrating a system configured to perform TDD coverage enhancement in FDD-TDD CA, according to an embodiment of the present invention.

FIG. 9 is a flow diagram illustrating a process for performing TDD coverage enhancement in FDD-TDD CA, according to an embodiment of the present invention.

FIG. 10A illustrates an example of a neural network that has been trained to assist with performing TDD coverage enhancement in FDD-TDD CA, according to an embodiment of the present invention.

FIG. 10B illustrates an example of a neuron, according to an embodiment of the present invention.

FIG. 11 is a flowchart illustrating a process for training AI/ML model(s), according to an embodiment of the present invention.

FIG. 12 is an architectural diagram illustrating a computing system configured to perform aspects of TDD coverage enhancement in FDD-TDD CA, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to TDD coverage enhancement in FDD-TDD CA. When analyzing the link budget, the TDD Physical Downlink Control Channel (PDCCH) is the coverage bottleneck of TDD-FDD CA. In other words, currently, the range of PDCCH communications for these TDD bands defines the maximum range in which UE devices can be located while using FDD-TDD CA, despite the wider coverage area provided by the FDD bands. For instance, in the case of CA between n71 (low-band FDD) and n77 (uplink (UL) limited TDD), the n77 DL coverage is smaller than the n71 UL coverage since the n77 DL PDCCH is the DL coverage limitation in the 8T8R configuration. There is no beamforming gain in the common control channel (i.e., PDCCH) while the Physical Downlink Shared Channel (PDSCH) coverage is improved from the beamforming gain. However, using the open interface and intelligent functions provided by the Open Radio Access Network (O-RAN) and Third Generation Partnership Project (3GPP) architecture, for example, some embodiments collect the PDCCH configurations of the serving cell and its adjacent cells and use PDCCH coverage improvement techniques suitable for each cell and user situation, thus expanding the area in which UE devices can use FDD-TDD CA.

The PDCCH is used to transfer Downlink Control Information (DCI). This corresponds to physical layer signaling from Layer 1 (L1), in contrast to Radio Resource Control (RRC) signaling from Layer 3 (L3) or the use of Medium Access Control (MAC) control elements from Layer 2 (L2). 3GPP has specified a set of DCI formats to accommodate a range of PDCCH payloads, provided in Table 1 below.

TABLE 1
DCI FORMATS

| DCI Format: | Description: |
|---|---|
| 0_0 | “Fallback” DCI format for uplink resource |
| | allocations on the Physical Uplink |
| | Shared Channel (PUSCH) |
| 0_1 | “Standard” DCI format for uplink |
| | resource allocations on the PUSCH |
| 1_0 | “Fallback” DCI format for downlink |
| | resource allocations on the PDSCH |
| 1_1 | “Standard” DCI format for downlink |
| | resource allocations on the PDSCH |
| 2_0 | Provision of Slot Format Indicators (SFIs) |
| 2_1 | Provision of preemption indications |
| 2_2 | Provision of closed loop power control |
| | commands applicable to the Physical Uplink |
| | Control Channel (PUCCH) AND PUSCH |
| 2_3 | Provision of closed loop power control |
| | commands applicable to the |
| | Sounding Reference Signal (SRS) |

“Fallback” DCI formats 0_0 and 1_0 can be used to maintain a connection for the PUSCH when coverage deteriorates. These formats have smaller payloads than “Standard” DCI formats 0_1 and 1_1, respectively. DCI formats 2_0, 2_1, 2_2, and 2_3 are used to provide “User Equipment (UE) Group Common Signaling.” These DCI formats are designed to address a group of UE devices and can accommodate payloads for each UE device within the group. The payload belonging to a specific UE device has a specific position within the DCI, so each UE device can extract its own information while ignoring the information intended for other UE devices.

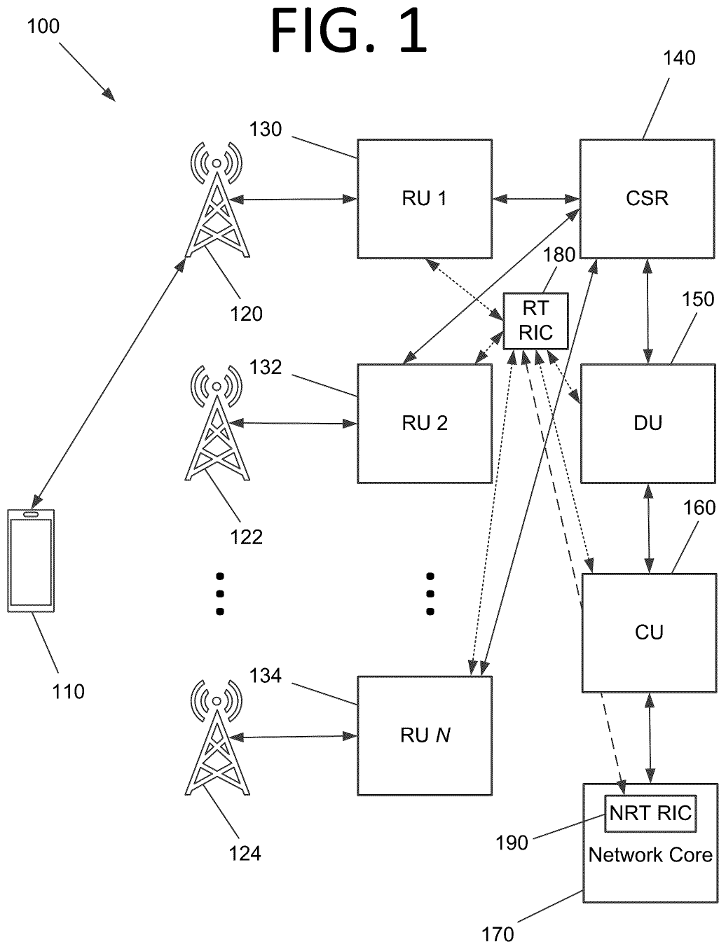

FIG. 1 is an architectural diagram illustrating an O-RAN 100 that is configured to provide TDD coverage enhancement in TDD-FDD CA, according to an embodiment of the present invention. While the example of O-RAN 100 is a Fifth Generation (5G) network, it should be noted some embodiments may be applied to older technologies (e.g., Fourth Generation (4G) networks) or to future technologies (i.e., Sixth Generation (6G) networks and beyond) without deviating from the scope of the invention. In the O-RAN architecture, RAN 100 includes three main building blocks: N Radio Units (RUs) 130, 132, . . . , 134, a Distributed Unit (DU) 150 (although more than one DU may be included in RAN 100), and a Centralized Unit (CU) 160 (although more than one CU may be included in RAN 100). Typically, there are more DUs than CUs in the O-RAN architecture.

The key concept of O-RAN is “opening” the protocols and interfaces between the various building blocks (i.e., radios, hardware, and software) in the RAN. The O-RAN Alliance has defined various interfaces within the RAN, including those for fronthaul between the RU and the DU, midhaul between the DU and the CU, and backhaul connecting the RAN to the network core. The CU accommodates the higher protocol stack layers while the DU accommodates the lower protocol stack layers.

In RAN 100, RUs 130, 132, . . . , 134 transmit, receive, amplify, and digitize radio frequency signals and are operably connected to and located near and/or integrated into N respective antennae 120, 122, . . . , 124 of their cell sites. Each cellular telecommunications tower may have multiple RUs of RUs 130, 132, . . . , 134 to fully service various bands for a particular coverage area. DU 150 receives the digitized radio signals from respective RUs 130, 132, . . . , 134 that it manages via a Cellular Site Router (CSR) 140 that routes traffic from RUs 130, 132, . . . , 134 to DU 150.

DUs are the main processing units that are responsible for the High Physical, MAC, and Radio Link Control (RLC) protocols in the RAN protocol stack under the 3GPP. In other words, DUs are a logical encapsulation of the 3GPP stack. In O-RAN or virtualized RAN (vRAN), DUs are typically servers based on an Intel® architecture that are optimized to run the real time RAN functions located below split 2 and to connect with the RUs through a fronthaul interface based on O-RAN split 7-2x. DUs perform L1 and L2 processing.

After performing High Physical, MAC, and RLC operations, DU 150 sends digitized radio signals to a CU 160 for further processing. CU 160 is responsible for non-real time, higher L2 and L3 functions. CU 160 also controls the operation of DU 150.

CU 160 runs the RRC and Packet Data Convergence Protocol (PDCP) layers. In 5G networks, a Next Generation Node B (gNB) may include CU 160 and DU 150, which is connected to CU 160 via Fs-C (control plane (CP)) and Fs-U (user plane (UP)) interfaces for the CP and UP, respectively. However, per the above, there are multiple DUs in RAN 100 in some embodiments. If CU 160 has multiple such DUs, CU 160 supports multiple gNBs. The split architecture allows a 5G network to utilize different distributions of protocol stacks between CU 160 and DUs, depending on midhaul availability and network design.

CU 160 is a logical node that includes gNB functions such as the transfer of user data, mobility control, RAN sharing (Multi-Operator RAN (MORAN)), positioning, session management etc., except for functions that are allocated exclusively to DU 150. CU 160 controls the operation of its DU(s) over the midhaul interface. In other words, CU 160 is connected to DU 150 via a midhaul link. CU 160 is also connected to a network core 170 via a backhaul link. Network core 170 is not technically part of RAN 100. In some embodiments, the backhaul link may be via satellite. Software of CU 160 can be co-located with DU software on the same server on site in some embodiments.

DU 150 is usually physically located at or near RUs 130, 132, . . . , 134 (e.g., at a cell site, in a Local Data Center (LDC), etc.), whereas CU 160 can be located nearer to network core 170 (e.g., in a Breakout Edge Data Center (BEDC)). In some cases, CU 160 may actually be located in network core 170. In some embodiments, DU 150 is offsite with respect to the cell site where respective RUs of RUs 130, 132, . . . , 134 are located, and DU 150 may be connected to CSR 140 by dark fiber, when available. For instance, dark fiber may connect CSR 140 to an LDC where DU 150 is housed. Alternatively, DU 150 may be located at the base of the cell site and connected to CU 160 via lit fiber.

A Near-Real Time RAN Intelligent Controller (RT RIC) 180 (also called a “Near-RT RIC” herein) runs xApps that interact with RUs 130, 132, . . . , 134, DU, 150, and CU 160. In some embodiments, RT RIC 180 is running on the same computing system that is running DU 150 and/or CU 160. RT RIC 180 should be located close to at least RUs 130, 132, . . . , 134 and DU 150 (and potentially CU 160 as well) since there are maximum latency constraints (e.g., 10 milliseconds to 1 second). Thus, RT RIC 180 may be located in an LDC or a BEDC if sufficiently proximate to these components. In some embodiments, RT RIC 180 may be where CU 160 is located or one level above CU 160 (controlling multiple CUs) and is part of the management entity for RAN 100.

RT RIC 180 uses its xApps to communicate with downstream Network Functions (NFs) through the E2 interface (shown as dotted lines), which is a network interface carrying events, control, and policy information to the O-RAN NFs. The downstream NFs can be gNB O-DU, gNB O-CU-CP, gNB O-CU-UP, and/or O-eNB, for example. The E2 interface allows southbound nodes to setup the E2 interface and register the list of applications the southbound nodes support, allows xApps running in RT RIC 180 to subscribe for events from the southbound nodes (e.g., as prescribe an action to execute upon encountering an event, such as report the event, report and wait for further control instructions from the xApp, or execute a policy), and provides control instructions.

Network core 170 includes a Non-Real Time RIC (NRT RIC) 190 (also called a “Non-RT RIC” herein) that runs various rApps, typically with more than 1 second latency. These rApps can communicate with RUs 130, 132, . . . , 134, DU, 150, and/or CU 160 indirectly via the backhaul interface between CU 160 and network core 170. NRT RIC 190 may be located in a BEDC, a Regional Data Center (RDC), a National Data Center (NDC), etc.

An A1 interface (shown by the dashed line between RT RIC 180 and NRT RIC 190) enables communication between RT RIC 180 and NRT RIC 190. The A1 interface supports policy management, data transfer, and machine learning management. The data (called “enrichment information”) sent via the A1 interface is used for assisting Artificial Intelligence (AI)/Machine Learning (ML) model training for RT RIC 180. In other words, the AI/ML models used by RT RIC 180 are deployed to RT RIC 180 by NRT RIC 190. The AI/ML models may also be trained by NRT RIC 190 in some embodiments. However, in certain embodiments, the AI/ML models may be deployed to RT RIC 180 by another application or computing system of network core 170.

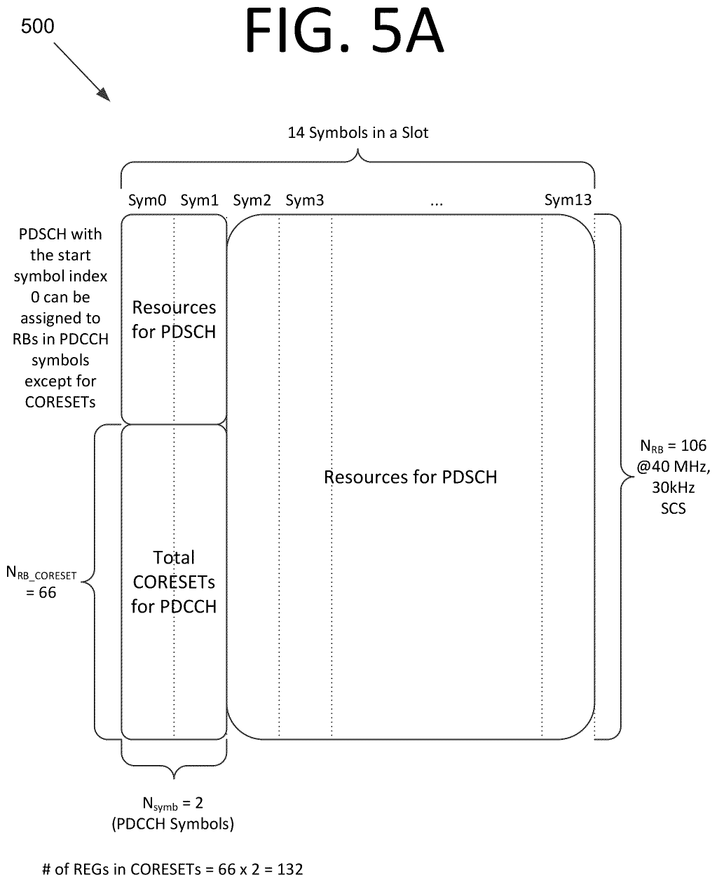

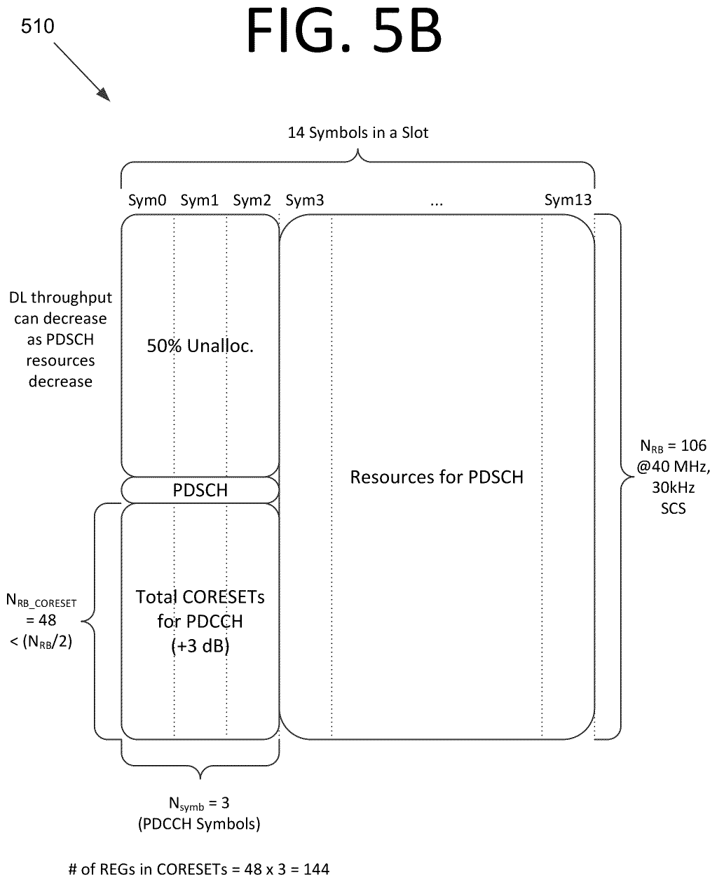

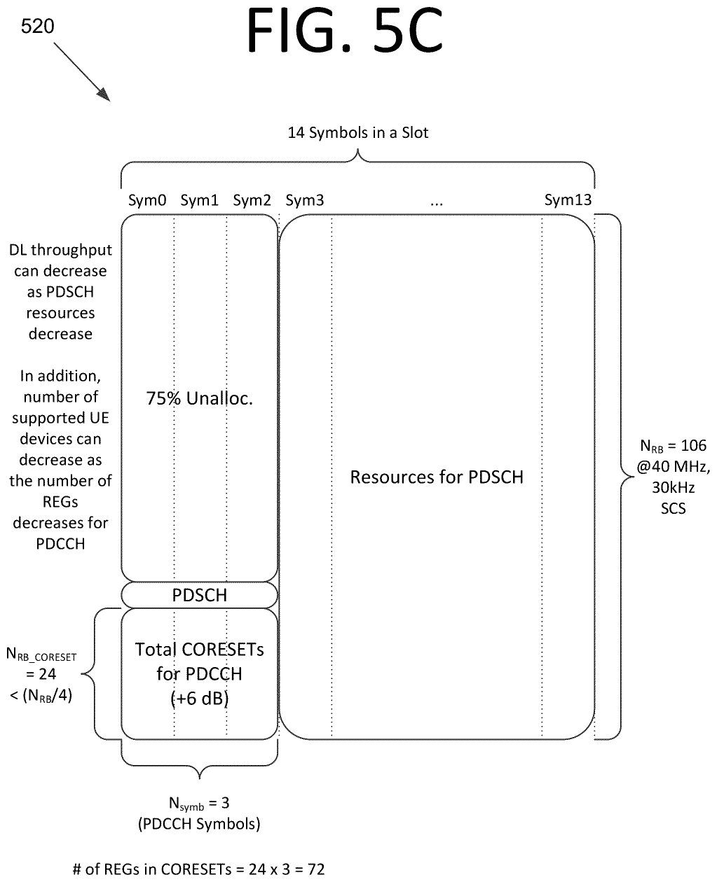

RT RIC 180 can acquire various data measurements from DU 150, detect users with insufficient PDCCH coverage, construct a PDCCH allocation map between the serving cell and its adjacent cells (see FIGS. 5A-C, 6A, and 6B, for example), exchange configuration information with the adjacent cells, and optimize PDCCH configurations for target users in near-real time. For instance, the PDCCH Aggregation Level (AL) may be changed, PDCCH power may be boosted, PDCCH beamforming and precoding may be performed, inter-cell PDCCH coordination may be performed, cross-carrier scheduling may be performed, multi-Transmission Reception Point (TRP) PDCCH transmission may be performed, etc. By doing so, the TDD coverage area can be expanded beyond what is possible using FDD-TDD CA alone.

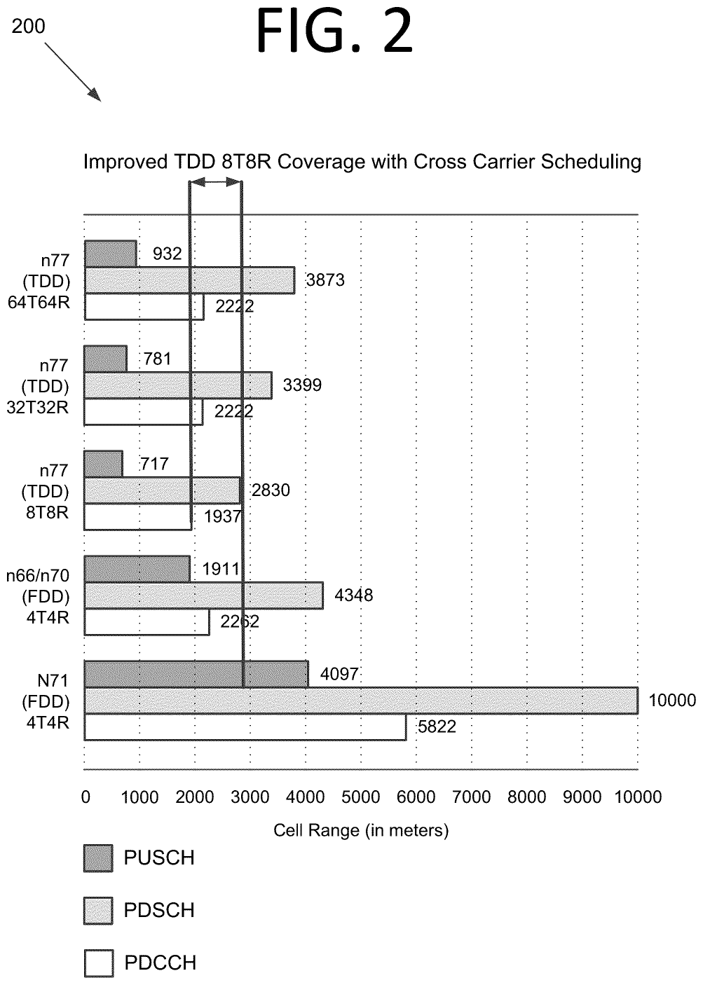

FIG. 2 is a graph 200 illustrating a link budget comparison for various 5G bands, according to an embodiment of the present invention. PDCCH is the limiting link for n77 band DL, which limits TDD coverage for this band to 1,937 meters for n77 8T8R, for example. Coverage can be further enhanced by approximately 4 to 5 decibels (dB) by leveraging FDD bands to schedule PDCCH for TDD bands. For instance, PDCCH coverage for FDD band n71 is 5,822 meters. In other words, the n71 band can be combined with the n77 band to improve cell site coverage.

In FIG. 2, the CA example is for the n77 TDD 8T8R and n71 FDD 4T4R bands. The n77 PDCCH coverage is smaller than the n77 PDSCH coverage, and actually, the n77 PDSCH coverage is limited by the n77 PDCCH coverage because the UE device cannot receive PDSCH without reception of PDCCH. However, the UE device can fully enjoy the original n77 PDSCH coverage by using CA cross-carrier scheduling in which DL control information for the n77 PDSCH can be transmitted via the n71 FDD PDCCH.

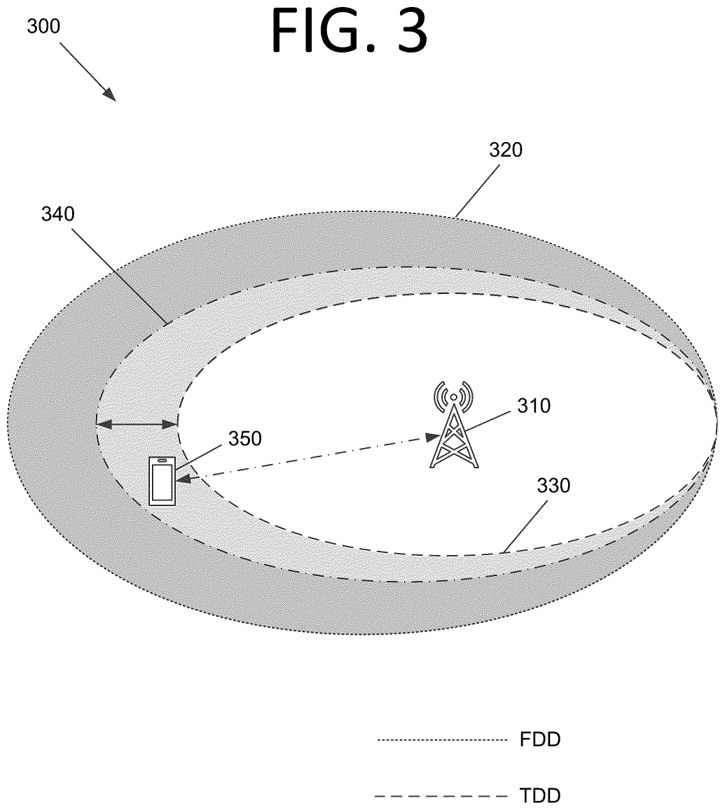

FIG. 3 is a coverage map 300 illustrating coverage areas provided by an FDD band (e.g., n71), a TDD band (e.g., n77), and FDD+TDD CA with TDD coverage enhancement, according to an embodiment of the present invention. A cell site 310 provides FDD coverage area 320 for an FDD band and a smaller TDD coverage area 330 for a TDD band. Per the above, using current FDD+TDD CA techniques limits the coverage area for FDD+TDD CA to that of TDD coverage area 330. Thus, to use FDD+TDD CA in current networks, mobile devices must be within TDD coverage area 330.

However, by improving PDCCH coverage, this increases FDD+TDD CA coverage to that of FDD+TDD CA coverage area 340. This allows mobile device 350 to use FDD+TDD CA and communicate with cell site 310 while within FDD+TDD CA coverage area 340. This includes both TDD coverage area 330 and the portion of FDD+TDD CA coverage area 340 that extends beyond TDD coverage area 330. In other words, UE device 350 can communicate with cell site 310 from further away than the maximum range provided by TDD coverage area 330.

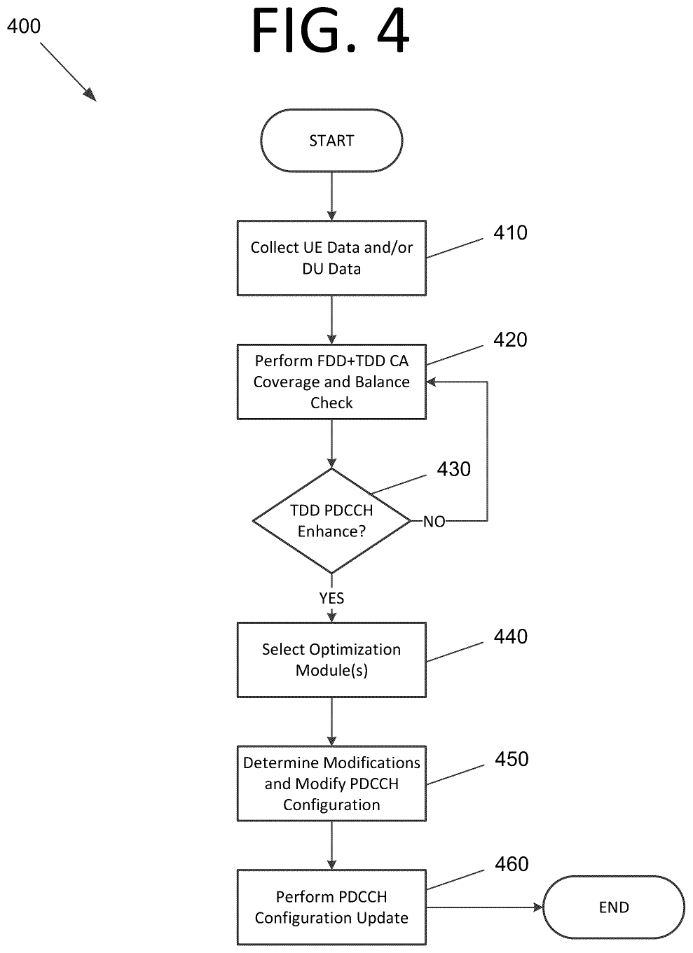

FIG. 4 is a flowchart illustrating a process 400 for providing TDD coverage enhancement in TDD-FDD CA, according to an embodiment of the present invention. The process begins with collecting UE data and/or DU data at 410. The UE data may include, but is not limited to, Synchronization Signal (SS) Reference Signal Received Power (SS-RSRP), SS Signal to Interference-plus-Noise Ratio (SS-SINR), UE status information (e.g., CA capabilities, the Primary Cell (PCell)—i.e., the cell that the UE exchanges RRC signaling messages with, TDD/FDD information), etc. The DU data may include, but is not limited to, CA status, aggregation level, boosting level, frequency domain resources, monitoring slot periodicity offset, precoder granularity, multi-TPR repetition support, cross-carrier scheduling support, etc. This information may be collected by DU(s), for instance, and relayed to an RT RIC. The data that is collected may be based on techniques that are expected to be beneficial in some embodiments.

The RT RIC uses the collected UE data and DU data to perform a CA coverage and balance check at 420. In some embodiments, this includes determining whether an expected TDD-to-FDD coverage ratio a link budget and a TDD-to-FDD PCell UE ratio from the collected measurement data are similar within a predetermined metric. For instance, a difference of 10% or more may be considered as the threshold. However, this may be modified as part of the AI/ML policy or optimization.

The number of CA UE devices that use a given cell as a PCell is proportional to the coverage of that cell. First, the number of CA UE devices attached to the FDD PCell and the TDD PCell, respectively, can be checked. For example, assuming uniform distribution of UE devices within the cell coverage area, the TDD-to-FDD coverage ratio that is expected from the link budget and the TDD-to-FDD PCell UE ratio from collected data should be similar. If this is the case, the process returns to step 410.

However, if the ratios are significantly different or the number of TDD PCell UE devices is smaller than expected, TDD coverage improvement/expansion may be desirable for TDD-FDD CA. Additionally, weights can be applied according to the ratio of FDD bandwidth and TDD bandwidth. If the TDD bandwidth is wider, the target TDD-to-FDD PCell UE ratio can be adjusted to have more UE devices in the TDD PCell. In other words, more bandwidth means more UE devices can be accommodated. If TDD-to-FDD PCell UE ratio is significantly outside the target, the balancing is likely broken and TDD coverage enhancement can be triggered at 430.

If the TDD PDCCH should be enhanced at 430 (e.g., due to the RT RIC detecting that one or more UE devices using FDD-TDD CA in a target TDD cell have insufficient coverage as defined by one or more metrics based on the CA coverage and balance check), a PDCCH optimization controller (e.g., an xApp running on the RT RIC that performs PDCCH optimization using AI/ML) performs optimization module selection at 440 based on a PDCCH policy. In some embodiments, the detecting that the one or more UE devices have insufficient coverage as defined by the one or more metrics includes determining that a respective SS-RSRP for a UE device is below a predetermined value, determining that a respective SS-SINR for the UE device is below a predetermined value, or both.

SS-SINR is typically a more accurate measurement. However, there may be UE devices that do not support SS-SINR. In principle, coverage is proportional to the RSRP value, so RSRP could be used first, and then SINR can be used together with RSRP to identify special cell edge environments, such as sector edges. When TDD coverage is improved, the RSRP and SINR reported from the UE devices in the TDD cell are the same. However, the number of UE devices capable of TDD-FDD CA increases, as well as the average throughput of the UE devices.

The PDCCH optimization controller updates the appropriate PDCCH configuration through multiple AI/ML model inferences. As used herein, an AI/ML model inference is logic of the PDCCH optimization controller that employs AI/ML for a given optimization technique. It should be noted, however, that the serving cell may not support all techniques or AI/ML model inferences discussed herein. Additionally, cell network operators may have preferred AI/ML model inferences that they would like to use.

The AI/ML model inferences may include, but are not limited to, a PDCCH AL change, a PDCCH power boost, PDCCH beamforming and precoding changes, inter-cell PDCCH coordination, cross-carrier scheduling, multi-TRP PDCCH transmission, or any combination thereof. The inputs to the AI/ML model inference(s) may include, but are not limited to, a CA status and UE measurements for cross-carrier scheduling, PDCCH beamforming and wideband precoding, and/or multi-TRP repetition for PDCCH, a current AL and boosting level for PDCCH AL management and PDCCH power boosting, frequency domain resources and monitoring slot periodicity and offset of neighboring cells for inter-cell PDCCH coordination, capabilities for cross-carrier scheduling, multi-TRP capabilities, or any combination thereof. The outputs from the AI/ML model inference(s) may include, but are not limited to, an updated AL and/or boosting level for PDCCH AL management and PDCCH power boosting, updated time-frequency parameters for inter-cell PDCCH coordination, cross-carrier scheduling on/off triggering, precoder granularity for PDCCH beamforming and wideband precoding, multi-TRP transmission or repetition on/off triggering, or any combination thereof.

The PDCCH policy defines the limits or preferences of the optimization model inferences. Mobile Network Operators (MNOs) have preferred or not preferred PDCCH coverage improvement techniques depending on the characteristics of the cells they operate. The PDCCH policy specifies these preferences in advance. For example, if cells in a specific region support only single-TRP transmission, the PDCCH policy should be set so that the multi-TRP-based techniques are not selected by the AI/ML xAPP in that region.

Thus, according to this policy, in some embodiments, only some of the model inferences can be selected to operate. That is the role of the PDCCH policy and the optimization module selection. For instance, if the PDCCH optimization controller supports changing the PDCCH AL, boosting the PDCCH power, performing PDCCH beamforming and precoding, performing inter-cell PDCCH coordination, performing cross-carrier scheduling, and performing multi-TRP PDCCH transmission, a subset of the respective optimization models for these techniques may be selected. Per the above, techniques used by the AI/ML xAPP are selected based on the policy, which depends on MNO preference and/or regional cell characteristics (e.g., centralized/distributed RAN, Multiple Input Multiple Output (MIMO) antenna configuration, DU scheduler capability, etc.).

For a given UE device, the RSRP and/or SINR measurement may be used to determine whether the UE device is at or near the edge of the TDD cell. Before installing a cell site, the MNO performs cell planning based on the link budget (i.e., the Maximum Allowable Path Loss (MAPL)). From the RSRP reported by the UE devices and the transmission power of the base station, the base station can calculate the path loss of each UE device. If the estimated path loss and the MAPL are within X dB, it can be determined that the UE device is at or near the cell boundary. The value of X can also be set by the MNO as a PDCCH policy or optimized as part of the AI/ML xAPP. Rather than changing all configurations in the TDD cell, it can be advantageous to update only the configurations that are beneficial for the cell edge UE devices. To do so, it is appropriate to specify the UE devices that would benefit from coverage improvement and utilize the measurement of those UE devices alone for subsequent optimization.

The PDCCH optimization controller uses the selected module(s) to perform optimization of the PDCCH configuration by inference at 450 and applies the modifications to the DU(s) and/or RU(s) to improve coverage of the TDD cell edge UE devices. In other words, the PDCCH optimization module determines modifications to the PDCCH settings for the UE device(s) based on the PDCCH-related policy and transmits the PDCCH settings modifications to at least one RAN node (e.g., DU(s), CU(s), RU(s), etc. in O-RAN) to implement the modifications to the PDCCH settings for the UE device(s). The PDCCH settings modifications may include updated PDCCH configuration parameters, adjacent-cell coordination parameters, PDCCH related feature triggers, any combination thereof, etc. In some embodiments, the determining of the modifications to the PDCCH settings for the UE device(s) based on the PDCCH-related policy includes selecting one or more AI/ML model inferences that match the PDCCH-related policy and using the selected AI/ML model inference(s) to determine the modifications to the PDCCH settings. In embodiments where adjacent cell coordination is performed, a PDCCH allocation map may be constructed between the target TDD cell and one or more adjacent cells, PDCCH configuration information is exchanged between the target TDD cell and the adjacent cell(s), and the exchanged PDCCH configuration information is used to coordinate the PDCCH settings modifications between the target TDD cell and the with one or more adjacent cells.

In some embodiments, the selected techniques may be applied in an order until the desired TDD coverage area expansion is achieved. For instance, the PDCCH AL may be increased first, and then power may be increased if the coverage improvement was insufficient, and then beamforming may be tried if the improvement to the coverage area is still insufficient. These techniques (inference models) are discussed below.

### PDCCH Aggregation Level Change

The PDCCH is used to convey scheduling information (i.e., resource allocation and control information for UL and DL to individual UE devices). The Control Resource Set (CORESET) is a bundle of physical resources for the PDCCH. Control information is modulated with Quadrature Phase Shift Keying (QPSK), and the modulated QPSK symbols are mapped to physical resources in units called Control Channel Elements (CCEs). Each CCE consists of six Resource Element Groups (REGs). REG is defined as one Physical Resource Block (PRB) in one Orthogonal Frequency Division Multiplexing (OFDM) symbol containing nine Resource Elements (REs) for the PDCCH payload and three Demodulation Reference Signal (DMRS) REs.

1, 2, 4, 8, or 16 CCEs can be assigned to control information where the number of CCEs is called the Aggregation Level (AL). As the AL increases, more resources are used. This, in turn, reduces the effective coding rate, and thus improves PDCCH coverage (reception performance). Instead, the number of supported PDCCHs (i.e., the number of UE devices) or PDSCH resources (i.e., the DL throughput) can be reduced. Once TDD coverage is insufficient, the AL of the TDD cell should be increased. However, to minimize side effects, the AL inference performed by this module may optimize the AL only for CA UE devices having TDD as the PCell that are at or near the TDD cell edge in some embodiments.

### PDCCH Power Boosting

If performance improvement beyond the maximum AL (i.e., 16) is desired, or additional performance improvements are desired while maintaining the current AL, PDCCH power boosting can be applied. For PDCCH power boosting, the L2 scheduler should limit the Resource Block (RB) usage in the PDCCH symbols by 50% for 3 dB boosting and limit the RB usage by 25% for 6 dB boosting because the overall symbol power should be maintained even if part of the symbol is boosted.

L1 software should support an in-phase-quadrature (I/Q) scaling function for PDCCH CORESETs. Examples of how to control RB usage in PDCCH symbols are provided in FIGS. 5A-C. More specifically, FIGS. 5A-C illustrate symbol and RB assignments in slots without power boosting, with a 3 dB power boost, and with a 6 dB power boost, respectively, according to an embodiment of the present invention. In slot 500 of FIG. 5A, the power is not boosted. The number of RBs allocated for the CORESETs (i.e., N_{RB_CORESET}) is 66 and the number of symbols is 2—namely, symbol 0 and symbol 1. The number of RBs (i.e., N_{RB}) allocated as resources for the PDSCH in symbols 2 to 13 is 106 at 40 megahertz (MHz) with a 30 kilohertz (kHz) Subcarrier Spacing (SCS).

However, in slot 510 of FIG. 5B, the power has been boosted by 3 dB. Accordingly, the CORESET configuration parameters are changed. Specifically, the number of RBs for the CORESETs and the number of symbols for the CORESETs are modified to 48 and 3, respectively. The number of RBs for the CORESETs is less than or equal to the total number of RBs divided by 2 for 3 dB boosting. In slot 520 of FIG. 5C, the number of RBs for the CORESETs and the number of symbols for the CORESETs are modified to 24 and 3, respectively. The number of RBs for the CORESETs is less than or equal to the total number of RBs divided by 4 for 6 dB boosting. Thus, the PDCCH start symbol parameter for some UE devices is changed from symbol 0 to symbol 3, which is after the PDCCH symbols. This inference utilizes a tradeoff between PDCCH coverage and PDSCH performance (i.e., DL throughput).

### PDCCH Beamforming and Precoding

New Radio (NR) supports both wideband and narrowband precoding for PDCCH. In essence, beamforming and precoding pertain to using the antenna array to transmit one or more spatially directive signals. Although not applicable in initial access, during CA operation, beamforming gain can be obtained through precoding not only on the PDSCH, but also on the PDCCH from the Precoding Matrix Index (PMI) feedback of each UE device. In wideband precoding, the PDCCH DMRS is transmitted on all consecutive REGs of the CORESET carrying the PDCCH using the same precoder. In O-RAN, the DU scheduler applies the same precoder to all REGs within a CORESET and informs the UE device using higher-layer signaling (precoder granularity=all contiguous RBs). The UE device performs channel estimation using DMRSs of all REGs, and PDCCH coverage can be increased by improving channel estimation performance at or near the TDD cell edge.

In narrowband precoding, the PDCCH DMRS is actually transmitted only in the REG bundle used for PDCCH transmission, and precoding is constant only within the REG bundle. The former can maximize frequency-domain processing gain, while the latter can utilize frequency-dependent beamforming gain. The same precoding is applied to the payload and the corresponding DMRS so the precoding is transparent to the UE device.

Inter-Cell PDCCH Coordination

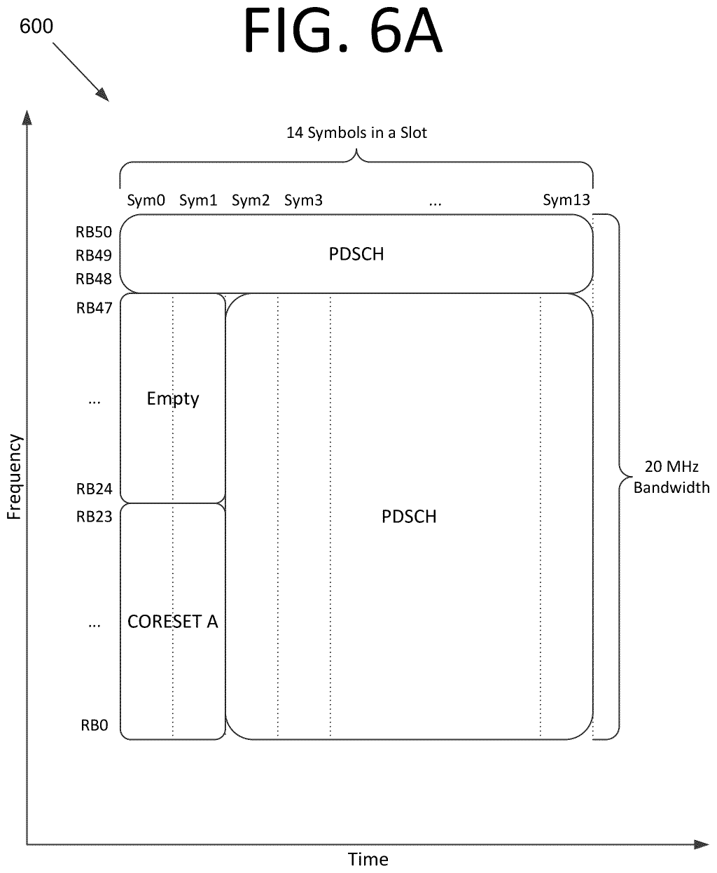

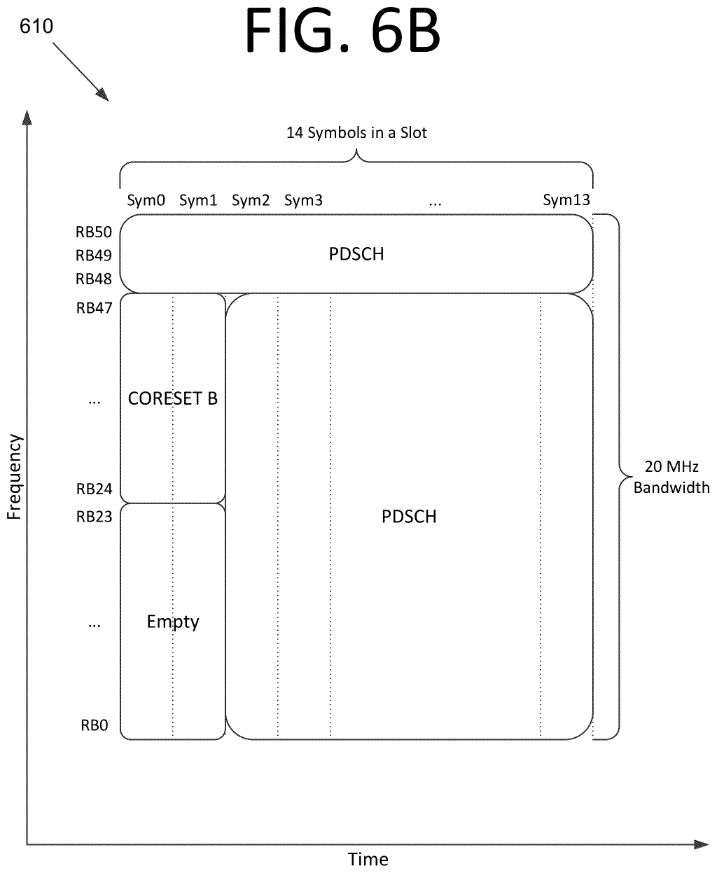

NR supports the CCE to REG mapping type: interleaved/non-interleaved for interference randomization. Per-cell CORESET shifting can be a more direct interference management technique. Such inter-cell coordination is shown in FIGS. 6A and 6B. For slot 600 for cell A, CORESET A is assigned to symbols 0 and 1 and RBs 0 to 23. RBs 24 to 47 are left empty and RBs 48 to 50 are assigned to PDSCH. Each RB may have 12 subcarriers, for example. The remaining RBs for symbols 2 to 13 are assigned to PDSCH. Cell B 610 is similar, but the CORESET assignment and the empty RBs in symbols 0 and 1 are switched. This inference model thus controls TDD PDCCH coverage by mitigating PDCCH interference between adjacent cell sectors.

### Cross-Carrier Scheduling

Cross-carrier scheduling can be a solution in FDD-TDD CA. To schedule each cell in the DL CA, the PDCCH is transmitted to each corresponding cell. If TDD PDCCH coverage is insufficient, TDD cells cannot be scheduled, and FDD-TDD CA coverage is reduced.

However, NR supports cross-carrier scheduling in CA operation. Using this, the PDCCH of a TDD Secondary Cell (SCell) can be transmitted in the downlink of an FDD PCell. The PDCCH coverage of low-band FDD (n71) is approximately 4.2 to 6.3 dB larger than that of high-band TDD (n77). As such, TDD resources can be scheduled with the low-band FDD PDCCH that has the larger coverage area. If both FDD and TDD UE devices are scheduled with FDD DL, FDD PDCCH resources may be insufficient. Thus, the inference model monitors FDD PDCCH resources and triggers cross-carrier scheduling only for CA UE devices having TDD as a PCell at or near the TDD cell edge in some embodiments.

It should be noted that this technique does not work for all FDD-TDD CA band combinations. For instance, the PDCCH coverage of mid-band FDD (n66) is approximately 1.2 to 3.3 dB smaller than that of TDD (n77). In such cases, cross-carrier scheduling is not beneficial.

### Multi-TRP Transmission for PDCCH

This inference model controls adjacent sectors to cooperate to perform multi-TRP or Coordinated Multi Point (CoMP) transmission. Single Frequency Network (SFN)-based PDCCH transmission can be performed through coherent joint transmission. Multiple TRPs are placed within a TDD cell and connected to a DU (in O-RAN) with very low latency. PDCCH coverage can be increased by sending PDCCH simultaneously in the same resource from different TRPs.

Non-SFN-based PDCCH transmission can be performed based on non-coherent joint transmission. Multiple TRPs of the serving TDD cell and neighboring TDD cells cooperate with one another other. PDCCH coverage can be increased by sending PDCCH repeatedly in the same or different resources (i.e., Control Channel Elements (CCEs) consisting of the same or different RBs) from different TRPs.

### Functional Framework for RAN Intelligence

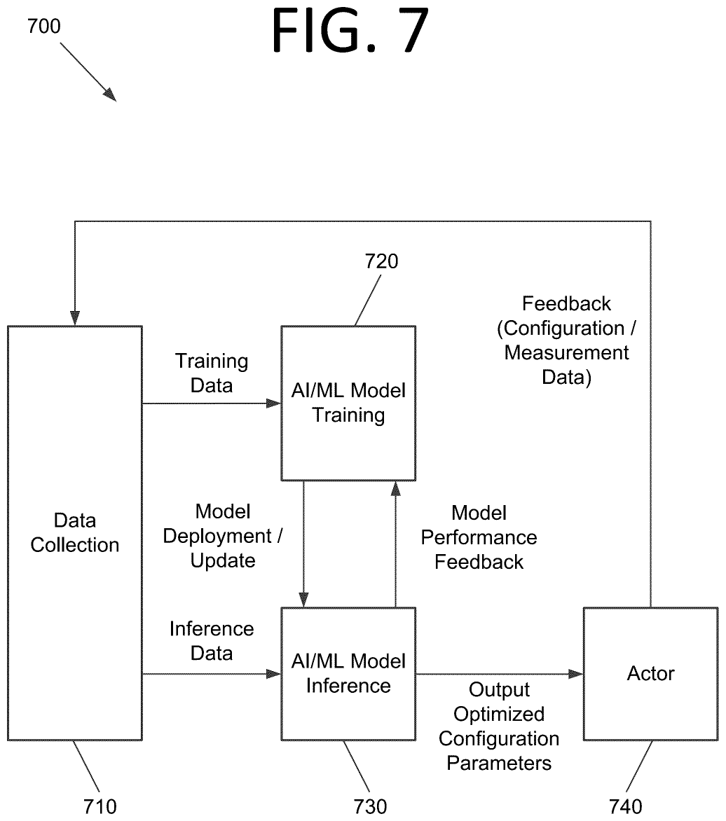

FIG. 7 is a flow diagram illustrating a functional framework 700 for RAN intelligence, according to an embodiment of the present invention. Data collection function 710 collects data and provides the collected data for AI/ML model training function 720 and AI/ML model inference function 730. Examples of the collected data include, but are not limited to, SS-RSRP and SS-SINR from UE devices, UE status information, measurement data from DUs, etc. An initial set of this data is collected and used for initial training of the AI/ML model(s). For instance, in some embodiments, AI/ML models may be trained to suggest PDCCH AL changes, PDCCH power boosts, PDCCH beamforming and precoding changes, inter-cell PDCCH coordination, cross-carrier scheduling, multi-TRP PDCCH transmission, etc. In some embodiments, the training of the AI/ML models may be performed by an NRT RIC, some other software in the network core, or external to the network core (e.g., in a third party cloud platform).

The AI/ML model(s) may be trained, validated, and tested during operation of AI/ML model training function 720. This generates model performance metrics as part of the model testing procedure. The model performance metrics may include the required SNR and error probability for PDCCH reception, which are indicators of PDCCH coverage improvement. The AI/ML model inference can be trained to reduce the required SNR or error rate for PDCCH reception. Once trained, the AI/ML model(s) are deployed for use in AI/ML model inference function 730. For instance, in some embodiments, the AI/ML model(s) may be deployed from an NRT RIC to an RT RIC via an A1 interface and called by an xApp of the RT RIC that functions as a PDCCH optimization controller.

Model inference function 730 monitors the network, determines whether PDCCH configuration changes should be made, and makes these changes using the trained AI/ML model(s). Model inference function 730 also receives inference data from data collection function 710. Model inference function 730 may further provide AI/ML model performance feedback to model training function 720 when applicable.

In general, it is not easy to obtain performance metrics during the model inference operation. For example, if PDCCH reception success or failure can be estimated from inference data during the model inference operation, this can be processed into a PDCCH error rate metric and fed back to model training function 720. This feedback can be used to update the model inference to be more suitable for the current cell environment.

Model inference function 730 may have various inputs and outputs. For instance, the inputs may include the CA status (TDD SCell) and UE measurements (e.g., SS-RSRP and SS-SINR) for cross-carrier scheduling, PDCCH beamforming and wideband precoding, and/or multi-TRP repetition for PDCCH, the current AL and boosting level for PDCCH AL management and PDCCH power boosting, frequency domain resources and monitoring slot periodicity and offset of neighboring cells for inter-cell PDCCH coordination, capabilities for cross-carrier scheduling, multi-TRP capabilities for multi-TRP, etc. The outputs may include the updated AL and/or boosting level for PDCCH AL management and PDCCH power boosting, updated time-frequency parameters for inter-cell PDCCH coordination, cross-carrier scheduling on/off triggering, precoder granularity for PDCCH beamforming and wideband precoding, multi-TRP transmission or repetition on/off triggering, etc.

The modified/optimized configuration parameters are output to an actor 740, which is a function that receives the output from model inference function 730 and performs the corresponding actions (i.e., configuration changes). Actor 740 may be software executing on a DU or an RU that makes changes to those components, for example. Actor 740 also provides feedback information to data collection function 710. The feedback may include, but is not limited to, information that may be needed to provide training data for updating the AI/ML model(s), inference data to provide to model inference function 730, information to update Key Performance Indicators (KPIs) and performance counters from monitoring the performance of the AI/ML model(s) and their impact on the network, etc. In other words, the system sends collected data measurements to a network core for retraining a respective AI/ML model associated with a respective AI/ML model inference of the one or more AI/ML model inferences, receives an updated AI/ML model from the network core, and uses the updated AI/ML model for the respective AI/ML model inference.

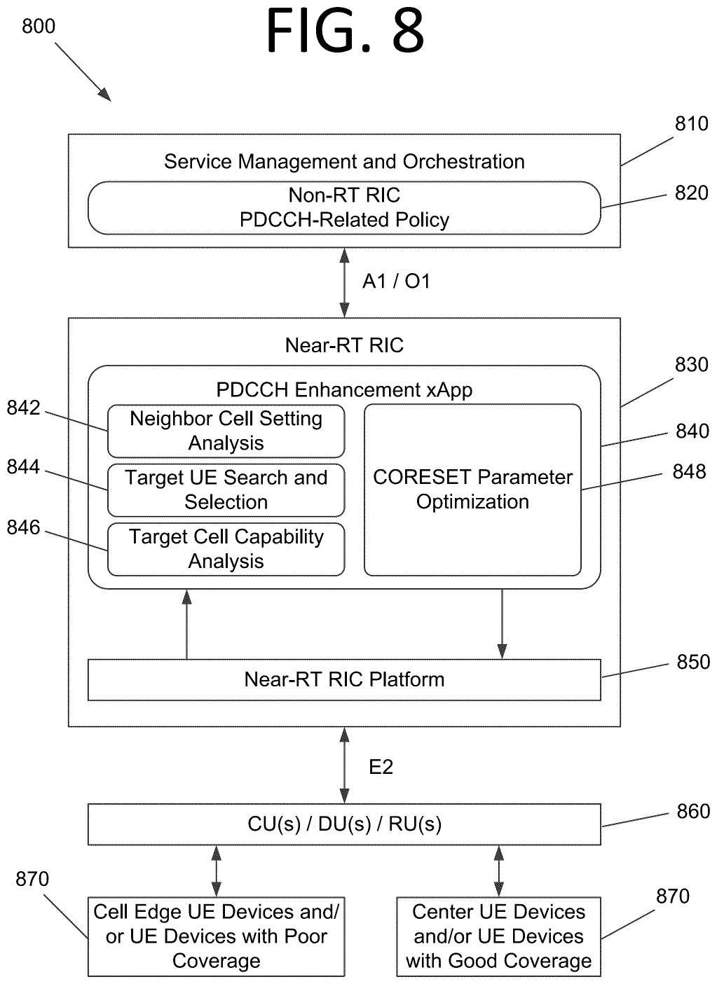

FIG. 8 is an architectural diagram illustrating a system 800 configured to perform TDD coverage enhancement in FDD-TDD CA, according to an embodiment of the present invention. Service management and orchestration 810 is performed in the network core, and a Non-RT RIC 820 manages PDCCH-related policy. The PDCCH policy is transferred from Non-RT RIC 820 to Near-RT RIC 830 via an A1 interface. The policy makes tradeoffs between PDCCH coverage and DL throughput. Key Performance Measurements (KPMs) such as S-RSRP and SS-SINR are also transferred from E2 nodes 860 to Near-RT RIC 830 via an E2 interface. The KPMs are collected from cell edge UE devices and/or UE devices in poor coverage 870, as well as center UE devices and/or UE devices in good coverage 872. RAN control parameters are also transferred from Near-RT RIC 830 to E2 nodes 860 via the E2 interface (i.e., CORESET-related parameters).

A PDCCH resource and power optimization xApp 840 is running on Near-RT RIC 830. PDCCH resource and power optimization xApp 840 performs neighbor cell setting analysis 842 (i.e., analyzes the CORESET parameters of neighboring cells to coordinate interference from the other cells), performs target UE search and selection 844 (i.e., searches for FDD-TDD CA UE devices that are suffering from TDD coverage shortages and selects these target UE devices), and performs target cell capability analysis 846 to determine the coverage enhancement capabilities of the target cell. PDCCH resource and power optimization xApp 840 also performs optimization 848 of the CORESET parameters of the target cell. Based on this analysis, a Near-RT RIC platform 850 transmits CORESET configuration changes to E2 nodes 860 via the E2 interface. Near-RT RIC platform 850 may be a container (e.g., a Kubernetes® container) on which multiple xAPPs can run, such as PDCCH enhancement xApp 840. E2 nodes 860 then implement the CORESET configuration changes, extending the coverage area of the TDD cell.

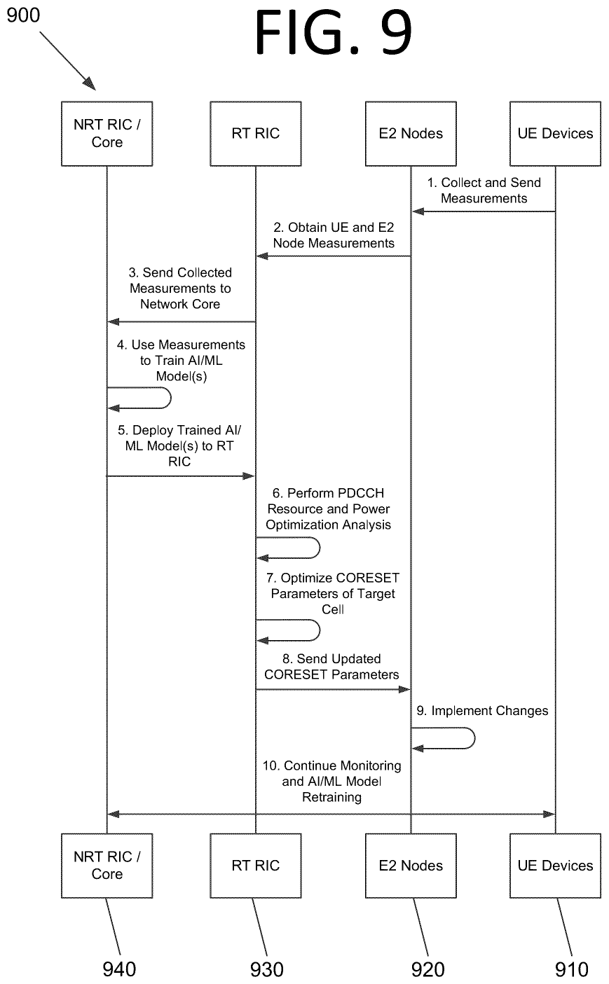

FIG. 9 is a flow diagram illustrating a process 900 for performing TDD coverage enhancement in FDD-TDD CA, according to an embodiment of the present invention. The process begins with collecting measurements and other data from UE devices 910 and sending this information to E2 nodes 920. The information may include, but is not limited to, SS-RSRP and SS-SINR from UE devices, UE status information, etc. An RT RIC 930 obtains this UE device information and measurements data from E2 Nodes 920 (e.g., data measured by DUs) and sends it to a network core 940. An NRT RIC of network core 940 or some other software then uses this data for training AI/ML models for the AI/ML model inferences. For instance, in some embodiments, the AI/ML models may be trained to suggest PDCCH AL changes, PDCCH power boosts, PDCCH beamforming and precoding changes, inter-cell PDCCH coordination, cross-carrier scheduling, multi-TRP PDCCH transmission, etc. Model inference metrics may also be generated during training.

After the AI/ML models are trained, NRT RIC 940 deploys the trained AI/ML models to RT RIC 930, as well as sends a PDCCH-related policy to RT RIC 930. An xApp of RT RIC 930 (e.g., a PDCCH optimization controller) monitors the network and determines whether PDCCH configuration changes should be made based on the PDCCH-related policy. For instance, RT RIC 930 may periodically or continuously repeat step 2 to obtain current network information and KPMs. This helps RT RIC 930 to determine which UE devices are cell edge UE devices and/or in poor coverage, as well as determine center UE devices and/or UE devices that are in good coverage.

The xApp of RT RIC 930 performs neighbor cell setting analysis, target UE search and selection, target cell capability analysis, and optimization of the CORESET parameters of the target cell. Based on this analysis, RT RIC 930 transmits CORESET configuration changes to E2 nodes 920 via the E2 interface. E2 nodes 920 then implement the CORESET configuration changes, extending the coverage area of the TDD cell. In other words, E2 nodes 920 implement these changes to extend the coverage area for the pertinent UE devices at or near the cell edge.

The process of monitoring the network, collecting data from UE devices 910 and E2 nodes 920, and providing this information to network core 940 is repeated by RT RIC 930. Network core 940 periodically uses this information to update one or more of the AI/ML models. In this manner, the AI/ML models can continuously be improved and deployed to increase the effectiveness of the TDD coverage enhancements.

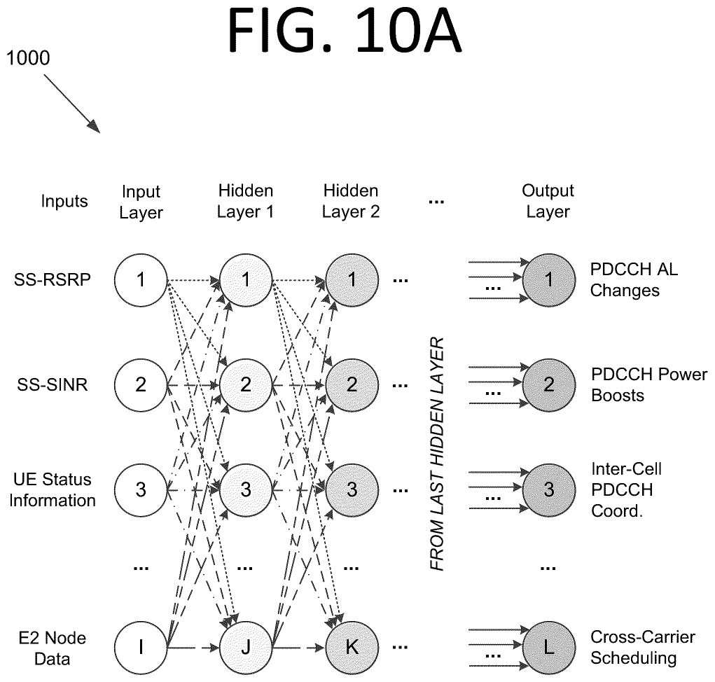

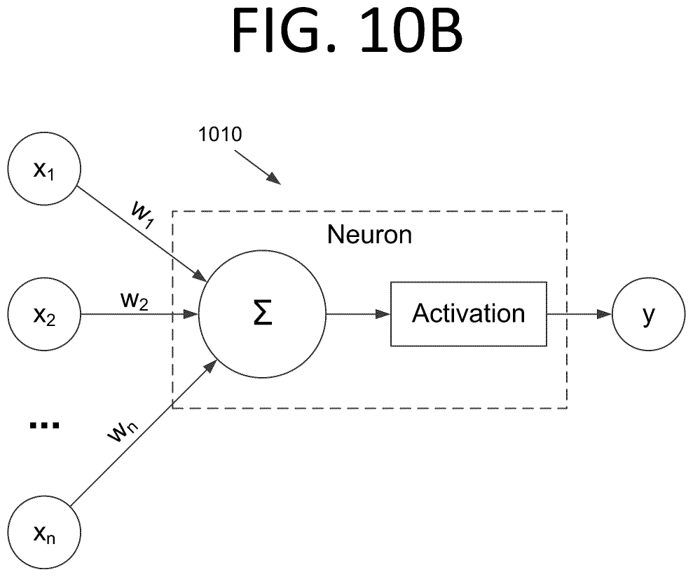

Per the above, AI/ML may be used in some embodiments. Various types of AI/ML models may be trained and deployed without deviating from the scope of the invention. For instance, FIG. 10A illustrates an example of a neural network 1000 that has been trained to assist with performing TDD coverage enhancement in FDD-TDD CA, according to an embodiment of the present invention.

Neural network 1000 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 1000.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 10A, SS-RSRP and SS-SINR from UE devices, UE status information, measurement data from E2 nodes, etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. The output layer suggests PDCCH AL changes, PDCCH power boosts, PDCCH beamforming and precoding changes, inter-cell PDCCH coordination, cross-carrier scheduling, multi-TRP PDCCH transmission, etc. It should be noted that numbers of neurons I, J, K, and L are not necessarily equal, and thus, any desired number of layers may be used for a given layer of neural network 1000 without deviating from the scope of the invention. Indeed, in certain embodiments, the types of neurons in a given layer may not all be the same. For instance, convolutional neurons, recurrent neurons, and/or transformer neurons may be used.

Neural network 1000 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative o and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 1010 is shown in FIG. 10B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function f(x) to determine whether the neuron “fires”. For instance, f(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 1010 may thus be given by:

$$y = f ( x ) {\sum }_{i = 1}^{m} ( {w}_{i} {x}_{i} ) + bias \qquad ( 3 )$$

In this case, neuron 1010 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the best core for a give service or application, determining when a network associated with a core is likely to be congested, etc.).

During training, various labeled data is fed through neural network 1000. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form pⱼ(nⱼ)=f′ⱼ(nⱼ), where nⱼ is the network activity at layer j (i.e., nⱼ=Wⱼoⱼ₋₁+bⱼ) where oⱼ=fⱼ(nⱼ) and the apostrophe ' denotes the derivative of the activity function f.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), ^{T} denotes the matrix transpose, and oⱼ denotes fⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Natural language processing (NLP) techniques such as word2vec, BERT, GPT-3, ChatGPT, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

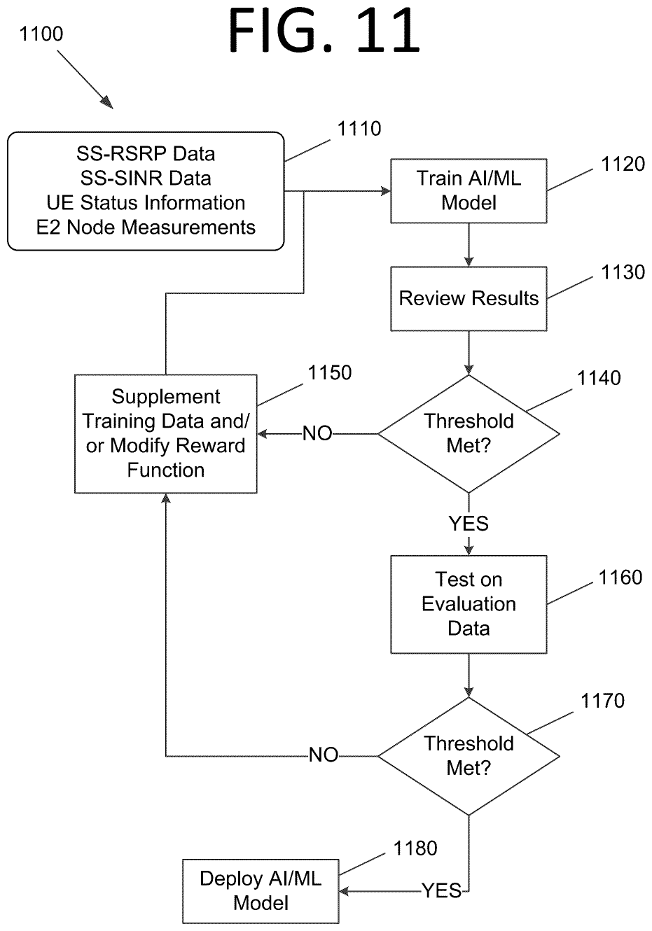

FIG. 11 is a flowchart illustrating a process 1100 for training AI/ML model(s), according to an embodiment of the present invention. The process begins with providing SS-RSRP and SS-SINR from UE devices, UE status information, measurement data from E2 nodes, etc. at 1110, whether labeled or unlabeled. Other training data used in addition to or in lieu of the training data shown in FIG. 11. Indeed, the nature of the training data that is provided will depend on the objective that the specific AI/ML model is intended to achieve. The AI/ML model is then trained over multiple epochs at 1120 and results are reviewed at 1130.

If the AI/ML model fails to meet a desired confidence threshold at 1140, the training data is supplemented and/or the reward function is modified to help the AI/ML model achieve its objectives better at 1150 and the process returns to step 1120. If the AI/ML model meets the confidence threshold at 1140, the AI/ML model is tested on evaluation data at 1160 to ensure that the AI/ML model generalizes well and that the AI/ML model is not over fit with respect to the training data. The evaluation data includes information that the AI/ML model has not processed before. If the confidence threshold is met at 1170 for the evaluation data, the AI/ML model is deployed at 1180. If not, the process returns to step 1150 and the AI/ML model is trained further.

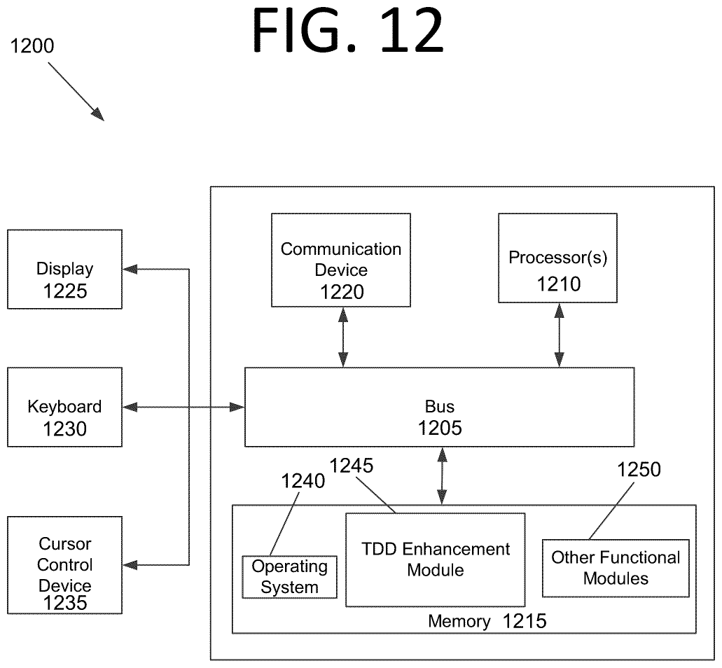

FIG. 12 is an architectural diagram illustrating a computing system 800 configured to perform aspects of TDD coverage enhancement in FDD-TDD CA, according to an embodiment of the present invention. In some embodiments, computing system 1200 may be one or more of the computing systems depicted and/or described herein, such as a mobile device, a base station, another computing system of a RAN (e.g., a Radio Unit (RU), a DU, or a CU in O-RAN), a computing system of the network core, a computing system of an RT RIC, a computing system of an NRT RIC, etc. Computing system 1200 includes a bus 1205 or other communication mechanism for communicating information, and processor(s) 1210 coupled to bus 1205 for processing information. Processor(s) 1210 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1210 may also have multiple processing cores, and at least some of the cores may be configured to perform specific functions. Multi-parallel processing may be used in some embodiments. In certain embodiments, at least one of processor(s) 1210 may be a neuromorphic circuit that includes processing elements that mimic biological neurons. In some embodiments, neuromorphic circuits may not require the typical components of a Von Neumann computing architecture.

Computing system 1200 further includes a memory 1215 for storing information and instructions to be executed by processor(s) 1210. Memory 1215 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available non-transitory media that can be accessed by processor(s) 1210 and may include volatile media, non-volatile media, or both. The media may also be removable, non-removable, or both.

Additionally, computing system 1200 includes a communication device 1220, such as a transceiver, to provide access to a communications network via a wireless and/or wired connection. In some embodiments, communication device 1220 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 1220 may include one or more antennas that are singular, arrayed, phased, switched, beamforming, beamsteering, a combination thereof, and or any other antenna configuration without deviating from the scope of the invention.

Processor(s) 1210 are further coupled via bus 1205 to a display 1225, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 1225 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 1230 and a cursor control device 1235, such as a computer mouse, a touchpad, etc., are further coupled to bus 1205 to enable a user to interface with computing system 1200. However, in certain embodiments, a physical keyboard and mouse may not be present, and the user may interact with the device solely through display 1225 and/or a touchpad (not shown). Any type and combination of input devices may be used as a matter of design choice. In certain embodiments, no physical input device and/or display is present. For instance, the user may interact with computing system 1200 remotely via another computing system in communication therewith, or computing system 1200 may operate autonomously.

Memory 1215 stores software modules that provide functionality when executed by processor(s) 1210. The modules include an operating system 1240 for computing system 1200. The modules further include a TDD enhancement module 845 that is configured to perform all or part of the processes described herein or derivatives thereof. Computing system 1200 may include one or more additional functional modules 1250 that include additional functionality.

One skilled in the art will appreciate that a “computing system” could be embodied as a server, a mobile device, a RAN or network core computing system, an embedded computing system, a quantum computing system, or any other suitable computing device or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 4, 7, 9, and 11 may be performed by computer program(s), encoding instructions for the processor(s) to perform at least part of the process(es) described in FIGS. 4, 7, 9, and 11 in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 1210 of computing system 1200 of FIG. 12) to implement all or part of the process steps described in FIGS. 4, 7, 9, and 11 which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs for performing Time Division Duplexing (TDD) coverage enhancement in Frequency Division Duplexing (FDD)-TDD Carrier Aggregation (CA), the one or more computer programs configured to cause at least one processor to:
collect data measurements from one or more Radio Access Network (RAN) nodes;
perform a CA coverage and balance check using the collected data measurements;
detect one or more User Equipment (UE) devices using FDD-TDD CA in a target TDD cell that have insufficient coverage as defined by one or more metrics based on the CA coverage and balance check;
determine modifications to Physical Downlink Control Channel (PDCCH) settings for the one or more UE devices based on a PDCCH-related policy; and
transmit the PDCCH settings modifications to at least one of the one or more RAN nodes to implement the modifications to the PDCCH settings for the one or more UE devices.

2. The one or more non-transitory computer-readable media of claim 1, wherein the detecting that the one or more UE devices have insufficient coverage as defined by the one or more metrics comprises determining that a respective Synchronization Signal (SS) Reference Signal Received Power (SS-RSRP) is below a predetermined value, determining that a respective SS Signal to Interference-plus-Noise Ratio (SS-SINR) is below a predetermined value, or both.

3. The one or more non-transitory computer-readable media of claim 1, wherein the determining of the modifications to the PDCCH settings for the one or more UE devices based on the PDCCH-related policy comprises:
selecting one or more Artificial Intelligence (AI)/Machine Learning (ML) model inferences that match the PDCCH-related policy; and
using the one or more selected AI/ML model inferences for the determining of the modifications to the PDCCH settings.

4. The one or more non-transitory computer-readable media of claim 3, wherein the one or more computer programs are further configured to cause the at least one processor to:
send the collected data measurements to a network core for retraining a respective AI/ML model associated with a respective AI/ML model inference of the one or more AI/ML model inferences;
receive an updated AI/ML model from the network core; and
use the updated AI/ML model for the respective AI/ML model inference.

5. The one or more non-transitory computer-readable media of claim 3, wherein the one or more AI/ML model inferences comprise a PDCCH Aggregation Level (AL) change, a PDCCH power boost, PDCCH beamforming and precoding changes, inter-cell PDCCH coordination, cross-carrier scheduling, multi-Transmission Reception Point (TRP) PDCCH transmission, or any combination thereof.

6. The one or more non-transitory computer-readable media of claim 5, wherein the inputs to the one or more AI/ML model inferences comprise a CA status and UE measurements for cross-carrier scheduling, PDCCH beamforming and wideband precoding, and/or multi-TRP repetition for PDCCH, a current AL and boosting level for PDCCH AL management and PDCCH power boosting, frequency domain resources and monitoring slot periodicity and offset of neighboring cells for inter-cell PDCCH coordination, capabilities for cross-carrier scheduling, multi-TRP capabilities, or any combination thereof.

7. The one or more non-transitory computer-readable media of claim 5, wherein the outputs from the one or more AI/ML model inferences comprise an updated AL and/or boosting level for PDCCH AL management and PDCCH power boosting, updated time-frequency parameters for inter-cell PDCCH coordination, cross-carrier scheduling on/off triggering, precoder granularity for PDCCH beamforming and wideband precoding, multi-TRP transmission or repetition on/off triggering, or any combination thereof.

8. The one or more non-transitory computer-readable media of claim 1, wherein the collected data measurements comprise CA status, SS-RSRP, SS-SINR, aggregation level, boosting level, frequency domain resources, monitoring slot periodicity offset, precoder granularity, multi-TPR repetition support, cross-carrier scheduling support, or any combination thereof.

9. The one or more non-transitory computer-readable media of claim 1, wherein the PDCCH settings modifications comprise updated PDCCH configuration parameters, adjacent-cell coordination parameters, PDCCH related feature triggers, or any combination thereof.

10. The one or more non-transitory computer-readable media of claim 1, wherein the one or more computer programs are further configured to cause the at least one processor to:
construct a PDCCH allocation map between the target TDD cell and one or more adjacent cells;
exchange PDCCH configuration information between the target TDD cell and the one or more adjacent cells; and
use the exchanged PDCCH configuration information to coordinate the PDCCH settings modifications between the target TDD cell and the with one or more adjacent cells.

11. The one or more non-transitory computer-readable media of claim 1, wherein the performing the CA coverage and balance check comprises determining whether an expected TDD-to-FDD coverage ratio a link budget and a TDD-to-FDD Primary Cell (PCell) UE ratio from the collected data measurements are similar within a predetermined metric.

12. The one or more non-transitory computer-readable media of claim 11 wherein the one or more computer programs are further configured to cause the at least one processor to:
apply weights to a ratio of FDD bandwidth and TDD bandwidth; and
responsive to determining that the TDD bandwidth is wider than the FDD bandwidth, adjusting the target TDD-to-FDD PCell UE ratio to add more UE devices to the target TDD cell.

13. The one or more non-transitory computer-readable media of claim 1, wherein
the one or more computer programs are respective xApps running on a Near-Real Time Ran Intelligent Controller (NT RIC) in the RAN, and
the RT RIC is configured to control the one or more RAN nodes to implement the PDCCH settings modifications.

14. One or more computing systems, comprising:
memory storing computer program instructions for performing Time Division Duplexing (TDD) coverage enhancement in Frequency Division Duplexing (FDD)-TDD Carrier Aggregation (CA); and
at least one processor configured to execute the computer program instructions, wherein the computer instructions are configured to cause the at least one processor to:
collect data measurements from one or more Radio Access Network (RAN) nodes,
detect one or more User Equipment (UE) devices using FDD-TDD CA in a target TDD cell that have insufficient coverage as defined by one or more metrics,
determine modifications to Physical Downlink Control Channel (PDCCH) settings for the one or more UE devices based on a PDCCH-related policy and one or more Artificial Intelligence (AI)/Machine Learning (ML) model inferences, and
transmit the PDCCH settings modifications to at least one of the one or more RAN nodes to implement the modifications to the PDCCH settings for the one or more UE devices to improve coverage for the one or more UE devices in the target TDD cell.

15. The one or more computing systems of claim 14, wherein the one or more AI/ML model inferences comprise a PDCCH Aggregation Level (AL) change, a PDCCH power boost, PDCCH beamforming and precoding changes, inter-cell PDCCH coordination, cross-carrier scheduling, multi-Transmission Reception Point (TRP) PDCCH transmission, or any combination thereof.

16. The one or more computing systems of claim 15, wherein
the inputs to the one or more AI/ML model inferences comprise a CA status and UE measurements for cross-carrier scheduling, PDCCH beamforming and wideband precoding, and/or multi-TRP repetition for PDCCH, a current AL and boosting level for PDCCH AL management and PDCCH power boosting, frequency domain resources and monitoring slot periodicity and offset of neighboring cells for inter-cell PDCCH coordination, capabilities for cross-carrier scheduling, multi-TRP capabilities, or any combination thereof, and
the outputs from the one or more AI/ML model inferences comprise an updated AL and/or boosting level for PDCCH AL management and PDCCH power boosting, updated time-frequency parameters for inter-cell PDCCH coordination, cross-carrier scheduling on/off triggering, precoder granularity for PDCCH beamforming and wideband precoding, multi-TRP transmission or repetition on/off triggering, or any combination thereof.

17. The one or more computing systems of claim 14, wherein the computer program instructions are further configured to cause the at least one processor to:
perform a CA coverage and balance check using the collected data measurements by determining whether an expected TDD-to-FDD coverage ratio a link budget and a TDD-to-FDD Primary Cell (PCell) UE ratio from the collected data measurements are similar within a predetermined metric, wherein
the detecting of the one or more UE devices using FDD-TDD CA in the target TDD cell that have insufficient coverage as defined by one or more metrics is based on the CA coverage and balance check.

18. A computer-implemented method for performing Time Division Duplexing (TDD) coverage enhancement in Frequency Division Duplexing (FDD)-TDD Carrier Aggregation (CA), comprising:
detecting one or more User Equipment (UE) devices using FDD-TDD CA in a target TDD cell that have insufficient coverage as defined by one or more metrics, by one or more computing systems;
determining modifications to Physical Downlink Control Channel (PDCCH) settings for the one or more UE devices based on a PDCCH-related policy and one or more Artificial Intelligence (AI)/Machine Learning (ML) model inferences, by the one or more computing systems; and
providing the PDCCH settings modifications to at least one of the one or more RAN nodes to implement the modifications to the PDCCH settings for the one or more UE devices to improve coverage for the one or more UE devices in the target TDD cell, by the one or more computing systems, wherein
the one or more AI/ML model inferences comprise a PDCCH Aggregation Level (AL) change, a PDCCH power boost, PDCCH beamforming and precoding changes, inter-cell PDCCH coordination, cross-carrier scheduling, multi-Transmission Reception Point (TRP) PDCCH transmission, or any combination thereof.

19. The computer-implemented method of claim 18, wherein
the inputs to the one or more AI/ML model inferences comprise a CA status and UE measurements for cross-carrier scheduling, PDCCH beamforming and wideband precoding, and/or multi-TRP repetition for PDCCH, a current AL and boosting level for PDCCH AL management and PDCCH power boosting, frequency domain resources and monitoring slot periodicity and offset of neighboring cells for inter-cell PDCCH coordination, capabilities for cross-carrier scheduling, multi-TRP capabilities, or any combination thereof, and
the outputs from the one or more AI/ML model inferences comprise an updated AL and/or boosting level for PDCCH AL management and PDCCH power boosting, updated time-frequency parameters for inter-cell PDCCH coordination, cross-carrier scheduling on/off triggering, precoder granularity for PDCCH beamforming and wideband precoding, multi-TRP transmission or repetition on/off triggering, or any combination thereof.

20. The computer-implemented method of claim 18, further comprising:
constructing a PDCCH allocation map between the target TDD cell and one or more adjacent cells, by the one or more computing systems;
exchanging PDCCH configuration information between the target TDD cell and the one or more adjacent cells, by the one or more computing systems; and
using the exchanged PDCCH configuration information to coordinate the PDCCH settings modifications between the target TDD cell and the with one or more adjacent cells, by the one or more computing systems.
